(19) United States
(12) Patent Application Publication
(10) Pub. No.: US 2005/0149619 A1
(43) Pub. Date: Jul. 7, 2005

(54) Methods, systems and storage medium for distributing content based on user communities

(76) Inventors: Keith O. Cowan, Atlanta, GA (US); Kim Littrell, Marietta, GA (US)

Correspondence Address: CANTOR COLBURN LLP, 55 GRIFFIN ROAD SOUTH, BLOOMFIELD, CT, 06002, US

(21) Appl. No.: 10/743,848

(22) Filed: Dec. 22, 2003

(51) Int. Cl. G06F 15/16

(52) U.S. Cl. 709/207

(57) ABSTRACT

A method of distributing content to consumers includes allowing a consumer to join a community and monitoring access to content by members of the community. A community interest in the content is determined in response to members of the community accessing the content. The content is automatically distributed to the consumer over a distribution network in response to the community interest.

### FIELD OF THE INVENTION

The present disclosure relates generally to delivering content and in particular, to providing content to users based on user communities.

### BACKGROUND

Systems exist for distributing content to users such as broadcast television, cable television, pay-per-view, etc. In such systems, the content provider dictates when content is available and the user may view the content at the scheduled time. Devices such as video cassette recorders (VCRs) and digital video recorders (DVRs), such as the TiVo® system provided by TiVo Inc. of Alviso, Calif., allow users to time-shift content and view the content at a time different from the broadcast time.

There is increasing desire by users for content on demand. In such systems, users can immediately obtain multimedia (e.g., motion pictures). Such systems need to address features such as billing, security, quality, etc. Embodiments of the invention are related to a content distribution system addressing these, and other features, of multimedia distribution.

### SUMMARY OF THE INVENTION

Embodiments of the invention include a method of distributing content to consumers. The method includes allowing a consumer to join a community and monitoring access to content by members of the community. A community interest in the content is determined in response to members of the community accessing the content. The content is automatically distributed to the consumer over a distribution network in response to the community interest. Further embodiments include a system and storage medium for implementing the method.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 depicts an exemplary content distribution network in embodiments of the invention.

FIG. 2 depicts an exemplary consumer network in embodiments of the invention.

FIG. 3 depicts an exemplary community portal user interface.

FIG. 4 depicts an exemplary database relating content to communities.

### DETAILED DESCRIPTION OF THE INVENTION

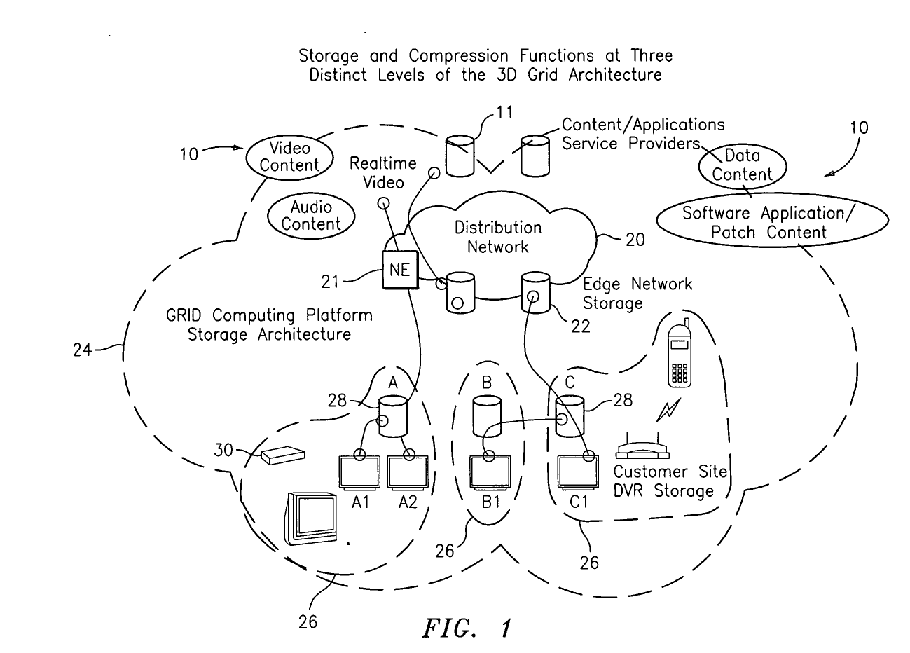

FIG. 1 depicts an exemplary video distribution architecture. The architecture is similar to that disclosed in U.S. patent application Ser. No. 10/605,928, filed Nov. 6, 2003 the entire contents of which are incorporated herein by reference. The video distribution architecture includes an underlying distribution network 20 and software infrastructure to support a video service platform. The major components of the architecture include content 10, the distribution network 20 (backbone and access), storage network 22, a grid computing platform 24, and consumer networks 26. It is understood that the consumer networks 26 are not limited to residential locations but may be any end user of the content.

The content 10 is made available through a distribution agreement between the content distribution system provider and the content owner. The content 10 may be a variety of audio-visual multimedia, such as television programs, movies, audio, consumer-generated content, etc. Consumer-generated content may be stored locally at consumer storage devices 28 (e.g., DVR) or other storage elements on distribution network 20. There is a defined process for adding new content into the network and an associated profile including digital rights, subscription rules, quality of service (QOS), and billing rules. Content is stored within content provider storage 11, network storage 22 as well as on the consumer storage devices 28 (e.g., DVR) at the consumer sites.

The distribution network 20 includes the backbone and the edge network. An IP core provides the backbone network for content distribution. The IP core interfaces with a variety of access networks and access network technologies. This includes ADSL networks as well as open cable networks, wireless DSL networks, and other access networks as required.

The video distribution architecture includes storage within the distribution network at the content provider storage 11, the network storage 22, perhaps at a centralized locations (e.g., central offices within a telecommunications network, a cable head end) as well as at the consumer storage devices 28 at the consumers' sites (e.g., DVR devices). The network storage 22 supports transmission of real-time video that is archived for future viewing and supports the transportation of non-real-time video between storage devices (e.g., consumer-to-consumer).

The grid computing platform 24 controls components of the distribution network 20. The grid computing platform 24 is provided by network elements executing grid applications. As described in further detail herein, the grid computing platform 24 is implemented using processor based network elements at a central office, at edges of the network, at the consumer location, etc. The grid applications control resources within the network including processing, bandwidth, and storage. The grid computing platform 24 provides the core applications platform for managing content and customer profiles including digital rights, subscriptions, billing, monitoring, etc.

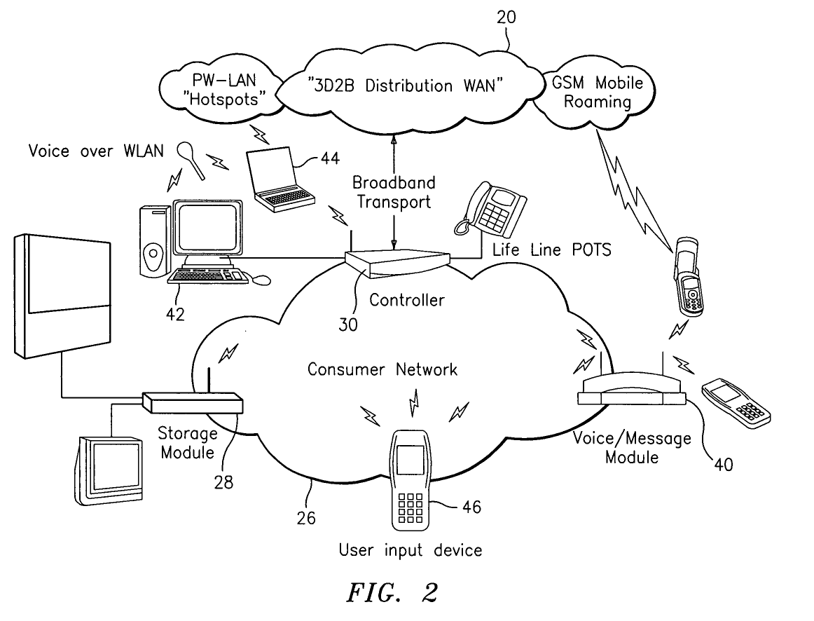

The consumer network 26 is the end user network that seamlessly unites all/any of the typical end-user's information appliances and devices as described in further detail with reference to FIG. 2. The consumer network 26 manages the receipt of content from the distribution network 20 and stores the content on one of the consumer storage devices 28 (e.g., DVR). The consumer network 26 may be based on a wireless networking standard such as 802.11e or wired network architectures such as a LAN, Ethernet, etc. or combinations or wired/wireless networking.

The distribution network 20 may include ADSL networks, open access cable, satellite, terrestrial broadcast and/or a wireless DSL platform. The distribution network 20 may be implemented over another ILEC's ADSL network or over cable modem access. The network operator derives value from the video service and the video revenue stream, not from the underlying access network. Further, the network owner may only need access to the underlying network rather than own the network outright.

The grid computing platform 24 is implemented using distributed network elements such as controller 30 (e.g., set-top box), the consumer storage devices 28 (which may be incorporated within controller 30), network storage devices 22 (e.g., at central office, data centers) and/or other network elements (e.g., processors at central office locations or other locations). The processor-based network elements may be implemented using a variety of components such as personal computers, servers, set top boxes, field programmable logic arrays, application specific integrated circuits, etc. These processor-based network element(s) determine based on customer preference, customer viewing habits or other reasons when to store a video program on the consumer storage device 28. Processor-based network element(s) decide where to store content that is not resident on the user's local consumer storage device 28. The grid computing platform 24 understands the network relationship between users to optimize network resources when content must be distributed from one consumer's storage device 28 to another consumer's storage device 28.

The grid computing platform 24 manages storage transparently to the consumer. The consumer is aware of the content they currently subscribe to and additional content that they may subscribe to in the future. The location of the content is transparent to the consumer. The consumer does not know and does not need to know if the content is on their local storage device 28 or being pulled from another storage device in the network. In FIG. 1, TV A1 pulls the program out of the resident DVR 28 while TV A2 displays real-time programming streamed over the distribution network 20. TV B1 pulls content from another consumer's DVR 28 while TV C1 pulls programming from a resident network storage device 22. Thus, content may be distributed from a variety of storage devices in the video distribution architecture.

FIG. 2 depicts an exemplary consumer network 26 in an embodiment of the invention. In one embodiment, the consumer network 26 is a residential home network, but similar networks may be employed in any setting where content is distributed. The consumer network 26 may be a wireless network that connects multiple devices using existing wireless network techniques (e.g., 802.11g/e/i, 802.11b, HPNA, Power Line Carrier, UWB). The controller 30 is coupled to the distribution network 20 and serves as a gateway device between the consumer network 26 and the distribution network 20.

The consumer network 26 includes associated home devices such as, but not limited to, DVR, TV, PC, PDA, game consoles, telephone, etc. Content may be provided through controller 30 to the consumer's storage device 28 (which may be incorporated within controller 30). A voice/message module 40 provides for wireless telecommunications services. Voice data may also be distributed to a personal computer 42 or laptop 44. Thus, the consumer network 26 provides communication between devices as well as connecting the consumer storage device 28 back to the distribution network 20 for distributing content to other consumers.

The consumer network 26 includes a handheld user input device 46 and associated navigating software to command and control voice, data and video applications. The consumer network 26 has a common control platform for managing devices on the consumer network 26. This includes the ability to navigate through a video programming guide. A simple and functional user interface to content is one aspect of the content distribution service. This interface promotes watching pre-loaded content thereby reducing the bandwidth across the distribution network 20. The interface highlights the breadth of content available on demand to move the consumer away from valuing cable broadcast services based on the number of channels. The consumer selects content through user input device 46. The interface provides advanced flexible features such as pause, rewind, and fast forward that are not provided by the broadcasters without a CPE upgrade. The user input device 46 provides such features to guide the consumer through the program guide.

One difficulty in having a large source of content 10 available to a large number of widely distributed consumer networks 26 is matching consumers with content of interest to each consumer. The content 10 may include past content (e.g., content broadcast previously), present content (e.g., today's broadcast television) and future contents (e.g., a movie to be released next month). Consumers may be overwhelmed when searching for content given the large amount of available content. To address this problem, embodiments of the invention use communities to assist consumers in locating content that may be desirable.

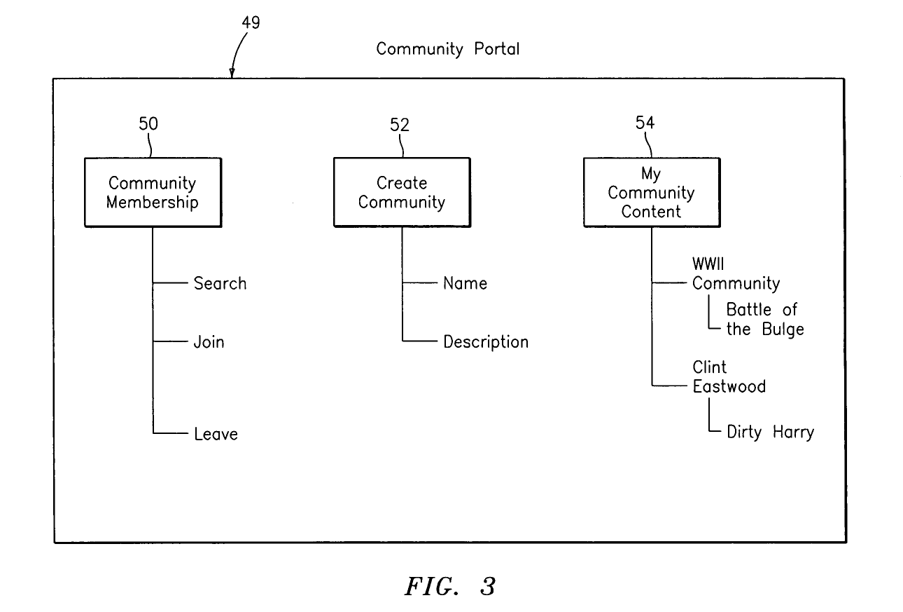

Through user input device 46, a consumer may access a community portal 49 as shown in FIG. 3. The community portal 49 may be provided by a processor-based device at the consumer's central office or through distributed computing by processor-based devices throughout grid computing platform 24. As shown in FIG. 3, the community portal 49 allows consumers to alter community membership, create their own communities and access content that has been distributed to the consumer storage device 28 based on the consumer's community membership.

Through a community membership icon 50, a consumer can search for communities, join communities or leave communities in which the consumer is currently a member. At least one network element (e.g., processor-based equipment that may be located at the consumer's serving central office) executes a software application for managing community membership and maintains a database of consumers and their respective community memberships. This information may be redundantly stored on distributed storage throughout the grid computing platform 24.

One option available to consumers upon joining a community is to have content 10 automatically distributed to the consumers' storage devices 28. As described in further detail herein, community activity is monitored to determine a community interest in the content. If the community interest is sufficient, the content may be automatically distributed to all members of that community. The consumer may elect not to have content automatically distributed to their consumer storage device 28 upon joining a community or editing community options.

Users may also create their own communities through create community icon 52. Selection of the create community icon 52 launches a routine through which the consumer may create a community by assigning a name and a description. Again, at least one network element (e.g., processor-based equipment at consumer's central office) executes a software application associated with the routine for creating communities, handling community name conflicts, etc. Once created, other consumers may join the newly created community through the community membership functions. Alternatively, consumers may be associated with communities by monitoring viewing habits and associating them with communities that have similar habits.

A community content icon 54 allows a consumer to access locally stored content on the consumer's storage device 28. The content is delivered automatically to the consumer's storage device based on the communities in which the consumer is a member. In the example shown in FIG. 3, the consumer is member of a World War II movie community and a Clint Eastwood movie community. Content, in the form of motion pictures, has been delivered to the consumer's storage device 28.

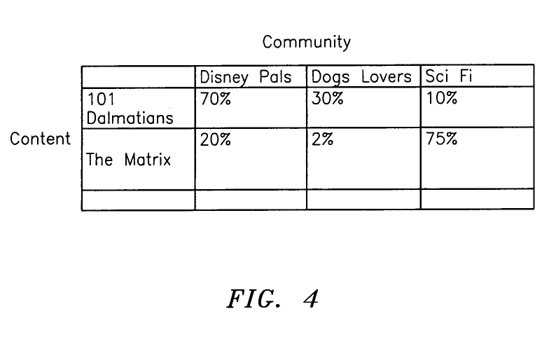

At least one network element (e.g., processor-based equipment at consumer's central office) executes a software application for determining what content may be desirable to a consumer. This level of interest is referenced as community interest. In one implementation, the network element establishes community interest by maintaining a record of the percentage of members in a community that have requested certain content. FIG. 4 depicts an exemplary database relating content to communities.

As shown in FIG. 4, the percentage of members in a community that have requested specific content. In the example in FIG. 4, 70% of the members of the Disney Pals community ordered the movie 101 Dalmatians. Thus, the community interest is 70%. The community interest may be compared to a reference value (e.g., 51%). If the community interest exceeds the reference value, then the network element determines that all members of that community may be interested in this content. The content, 101 Dalmatians in this example, is then automatically distributed to all members of the community, Disney Pals in this example. The content may be distributed to consumer storage devices 28 at a time when network bandwidth is more available (e.g., over night). Overall usage patterns of users in the community may be analyzed in near-real time by network elements as the requests are being made to determine whether the content should be distributed immediately or queued for later distribution. The analysis may include community viewing habits, individual viewing habits, historical network load, and/or current network load.

The consumer may then view the content at their convenience. Billing features are built into the consumer's home controller 30 such that when the content is played, a signal is generated back to a network element (e.g., processor at the consumer's central office). The network element then initiates the appropriate billing procedure to charge the consumer for accessing the content. The ability to view the content may expire after a certain period of time (e.g., the content becomes inaccessible after a certain date).

As described above, embodiments can be embodied in the form of computer-implemented processes and apparatuses for practicing those processes. Exemplary embodiments are embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits and/or execute certain process flows.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of distributing content to consumers, the method comprising:
allowing a consumer to join a community;
monitoring access to content by members of the community;
determining a community interest in the content in response to members of the community accessing the content; and
automatically distributing the content to the consumer over a distribution network in response to the community interest.

2. The method of claim 1 wherein:
the community interest is determined based on the percentage of members in the community that have accessed the content.

3. The method of claim 2 wherein:
the community interest is compared to a reference to initiate the automatically distributing

4. The method of claim 1 wherein:
the automatically distributing includes storing the content on a consumer storage device associated with the consumer.

5. The method of claim 4 further comprising:
notifying the consumer that the content is available on the consumer storage device; and
billing the consumer upon the consumer accessing the content on the consumer storage device.

6. The method of claim 1 wherein:
the automatically distributing the content is dependent on a consumer preference to receive automatically distributed content.

7. A system for distributing content to consumers, the system comprising:
a network clement receiving a request from a consumer to join a community;
a database coupled to the network element maintaining records of one or more communities associated with the consumer;
a consumer network in communication with the network element;
the network element monitoring access to content by members of the community, the network element determining a community interest in the content in response to members of the community accessing the content;
the network element automatically distributing the content to the consumer network in response to the community interest.

8. The system of claim 7 wherein:
the community interest is determined based on the percentage of members in the community that have accessed the content.

9. The system of claim 8 wherein:
the community interest is compared to a reference to initiate the automatically distributing

10. The system of claim 7 wherein:
the consumer network includes a consumer storage device;
the network element automatically distributing the content to the consumer storage device associated with the consumer.

11. The system of claim 10 wherein:
the network element notifies the consumer that the content is available on the consumer storage device;
the network element billing the consumer upon the consumer accessing the content on the consumer storage device.

12. The system of claim 7 wherein:
the network element automatically distributes the content in dependence on a consumer preference to receive automatically distributed content.

13. The system of claim 7 wherein:
the network element includes a plurality of network elements arranged in a grid computing network.

14. A storage medium encoded with machine-readable computer program code for distributing content to consumers, the storage medium including instructions for causing at least one network element to implement a method comprising:
allowing a consumer to join a community;
monitoring access to content by members of the community;
determining a community interest in the content in response to members of the community accessing the content; and
automatically distributing the content to the consumer over a distribution network in response to the community interest.

15. The storage medium of claim 14 wherein:
the community interest is determined based on the percentage of members in the community that have accessed the content.

16. The storage medium of claim 15 wherein:
the community interest is compared to a reference to initiate the automatically distributing

17. The storage medium of claim 14 wherein:
the automatically distributing includes storing the content on a consumer storage device associated with the consumer.

18. The storage medium of claim 17 further comprising instructions for causing at least one network element to implement:
notifying the consumer that the content is available on the consumer storage device; and
billing the consumer upon the consumer accessing the content on the consumer storage device.

19. The storage medium of claim 14 wherein:
the automatically distributing the content is dependent on a consumer preference to receive automatically distributed content.

20. The method of claim 1 wherein:
the content includes at least one of video, audio and consumer-generated content.

21. (canceled)

22. A controller for controlling distribution of content, the controller comprising:
means for receiving input from a consumer to join a community, means for receiving content having a community interest in the content in response to members of the community accessing the content; and
means for notifying the consumer that the content is available.
